(19) United States
(12) Patent Application Publication
(10) Pub. No.: US 2007/0146132 A1
(43) Pub. Date: Jun. 28, 2007

(54) Tamper detection system, method and apparatus

(76) Inventors: Florian Krug, Munich (DE); Joerg Stromberger, Buchenbach (DE); Walter Vincent Dixon, Delanson, NY (US); Oliver Gerhard Mayer, Muenchen (DE); Marcus Alexander Zettl, Grosshelfendorf (DE)

Correspondence Address: Patrick S. Yoder;FLETCHER YODER, P.O. Box 692289, Houston, TX, 77269-2289, US

(21) Appl. No.: 11/315,455

(22) Filed: Dec. 22, 2005

(51) Int. Cl. G08B 13/18

(52) U.S. Cl. 340/553

(57) ABSTRACT

A tamper and/or intrusion detection system is provided for making a structure tamperproof. The tamper and/or intrusion detection system includes an energy source for transmitting energy through an energy-transmitting layer, and a detector for detecting a change in energy distribution within the energy-transmitting layer.

### STATEMENT REGARDING FEDERALLY SPONSORED RESEARCH & DEVELOPMENT

This invention was made with Government support under contract number N66001-05-C-6015 awarded by SPACE AND NAVAL WARFARE SYSTEMS CENTER, San Diego. The Government has certain rights in the invention.

### BACKGROUND

The invention relates generally to security systems, and more specifically to techniques for detecting tamper and/or intrusion in secure environments, such as cargo containers, packages, doors and/or windows.

A wide variety of freights, such as commercial goods and equipment, quality assured equipment, confidential goods, sensitive material or equipment, expensive goods and so forth, are transferred from one place to other in standardized containers, such as cargo containers, crates, cardboard boxes, and/or packages. It is often difficult to adequately guard these containers while they are in transit or during storage. Further, some shipments originate in countries where port or rail yard security may not be adequate. Thus, these containers are often unattended for significant periods at locations in which theft or tampering can occur. Moreover, the sheer number of containers and boxes being shipped every day makes it difficult to adequately inspect each container at various checkpoints during transit or otherwise decreases the throughput at the checkpoints.

Additionally, in many cases such breaches or tampering are difficult to detect. Even a visual inspection of the exterior of a container is unlikely to reveal a breach. Shipping containers are subject to rough handling by cranes and other heavy equipment. Many of them have been damaged multiple times in the natural course of business and subsequently patched to extend their useful lives. Thus, upon inspection, a surreptitiously breached and patched container may appear same and the breached container is unlikely to be detected.

Consequently, these containers are subject to tampering. A breached container can, for example, be looted or surreptitiously loaded with contraband, such as illegal drugs and/or weapons. The need for security during transit and storage requires proof that a container's integrity was maintained. In addition, theft of goods from private or public entities during transit or storage is also undesirable and may have significant economic impacts. Accordingly, reducing such illegal activities is highly desirable.

The current techniques of securing containers during transit and/or storage depend primarily upon placing a seal across the locking mechanism of a container door and/or one or more physical inspections of the container to verify the integrity of contents and absence of tampering. However the above technique is of limited value because an intruder may circumvent or corrupt inventory controls and cargo manifest delivery systems with help. Further, considering the enormous amount of shipped goods, a manual inspection may decrease the throughput if inspection is carried out extensively or the inspection may not be as extensive and efficient otherwise. Since a breach or circumvention of a cargo delivery system may have serious consequences, particularly for high sensitive applications, the failure tolerance is very low. Thus, it is necessary to secure the containers such that intrusion is preventable and/or detectable.

Apart from securing containers and freights, it may also be desirable to secure various premises such as residential areas, public installations, defense installations, private property and so forth. Current techniques for securing such premises include installing an alarm systems based on acoustic sensors, shock sensors, magnetic contacts and triple-biased door contacts in doors and/or windows of such secured areas. However, these techniques do not protect the whole assembly or detect just an effect of the intrusion (e.g. sound or vibration) and not the intrusion itself. But these effects may also result form other events, thereby causing false alarms. Other techniques may detect only the opening of the door but generate no alarm if the locks are in place and the intrusion takes place by cutting through the door. Thus, an intrusion detection system is needed that provides a reliable full detection of unauthorized entrance through door and/or windows while minimizing the amount of false error messages.

It is therefore desirable to provide an efficient, reliable, cost-effective and automated tamper and/or intrusion detection system for cargo containers, packages, doors and/or windows. It is also desirable to provide tamperproof containers, packages, doors and/or windows.

### BRIEF DESCRIPTION

Briefly in accordance with one aspect of the present technique, a tamper detection system is provided. The tamper detection system includes an energy source for transmitting energy through an energy-transmitting layer, and a detector for detecting a change in energy distribution within the energy-transmitting layer.

In accordance with another aspect of the present technique, a tamperproof structure is provided. The tamperproof structure includes at least one surface vulnerable to breach, the surface comprising an energy-transmitting layer. The tamperproof structure further includes an energy source for transmitting energy through the energy-transmitting layer, and a detector for detecting a change in energy distribution within the energy-transmitting layer.

In accordance with a further aspect of the present technique, a kit is provided for upgrading a structure. The kit includes an energy-transmitting layer, and an energy source configured to be disposed on one end of the energy-transmitting layer. The energy source is adapted to create an energy distribution profile within the energy-transmitting layer. The kit also includes a detector configured to be disposed on another end of the energy-transmitting layer. The detector is configured to detect a change in the energy distribution profile.

In accordance with an additional aspect of the present technique, a method is provided for detecting tampering of a surface vulnerable to breach. The method provides for creating an energy distribution profile within an energy-transmitting layer, and detecting a change in the energy distribution profile. The energy-transmitting layer is disposed on or within the surface vulnerable to breach.

In accordance with another aspect of the present technique, a method is provided for making a structure tamperproof. The method provides for disposing an energy-transmitting layer on or within a surface of the structure, the surface being vulnerable to breach. The method also provides for disposing an energy source on one end of the energy-transmitting layer, and disposing a detector on another end of the energy-transmitting layer.

### DRAWINGS

These and other features, aspects, and advantages of the present invention will become better understood when the following detailed description is read with reference to the accompanying drawings in which like characters represent like parts throughout the drawings, wherein:

FIG. 1 depicts a block diagram of an exemplary tamper and/or intrusion detection system in accordance with aspects of the present technique;

FIG. 2 depicts a detailed representation of the tamper and/or intrusion detection system of FIG. 1;

FIG. 3 depicts a tamperproof cargo container or a tamperproof structure in accordance with aspects of the present technique;

FIG. 4 depicts an overall plan of one of the surfaces of the tamperproof structure of FIG. 3 that is vulnerable to breach in accordance with one aspect of the present technique;

FIG. 5 depicts a planar view of one of the surfaces of the tamperproof structure of FIG. 3 that is vulnerable to breach;

FIG. 6 depicts a cross sectional view of one of the surfaces of the tamperproof structure of FIG. 3 that is vulnerable to breach;

FIG. 7 depicts a retrofit solution to make an existing structure tamperproof in accordance with aspects of the present technique;

FIG. 8 depicts a schematic arrangement to provide an illumination to the tamper and/or intrusion detection system in accordance with one aspect of the present technique;

FIG. 9 depicts an emitter-sensor package for installation in the tamperproof structure in accordance with one aspect of the present technique;

FIG. 10 depicts a premise employing tamper and/or intrusion detection system to prevent intrusion in accordance with aspects of the present technique;

FIG. 11 depicts a cross section view of doors, walls or windows of the premise of FIG. 10 in accordance with aspects of the present technique;

FIG. 12 depicts tamperproof hinges in accordance with aspects of the present technique; and

FIG. 13 depicts tamperproof locking system in accordance with aspects of the present technique.

### DETAILED DESCRIPTION

The present techniques are generally directed to tamper and/or intrusion detection systems that may be useful in a variety of security applications. Though the present discussion provides examples in the context of cargo containers, packages, doors and/or windows, one of ordinary skill in the art will readily comprehend that the application of these techniques in other contexts is well within the scope of the present disclosure.

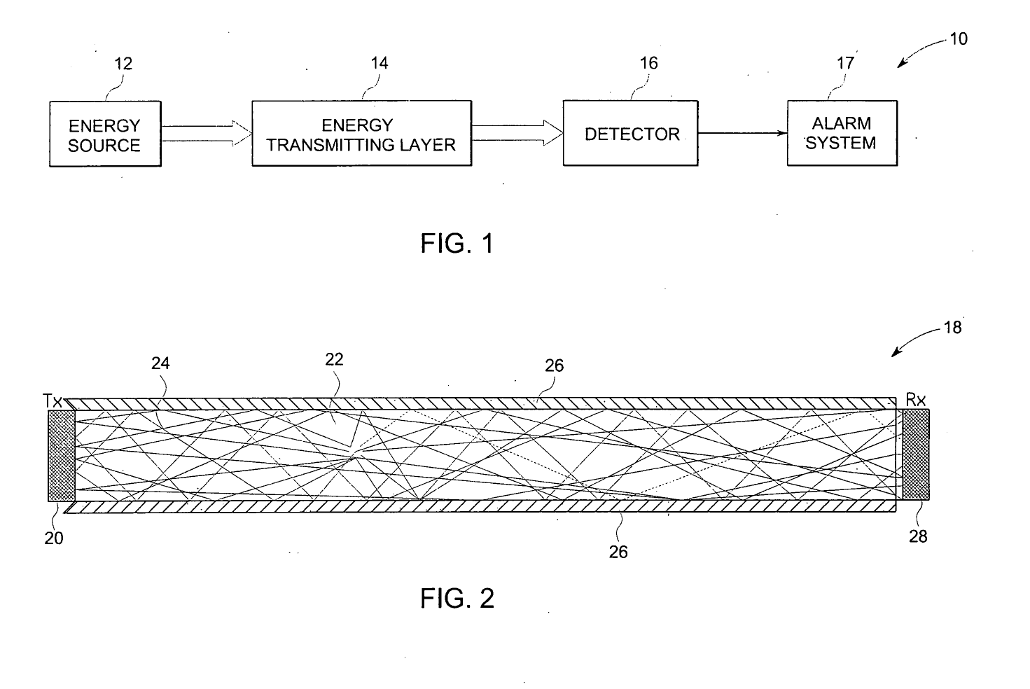

Referring now to FIG. 1, a block diagram of an exemplary tamper and/or intrusion detection system 10 is illustrated in accordance with aspects of the present technique. The tamper and/or intrusion detection system 10 includes an energy source 12 for transmitting energy through an energy-transmitting layer 14, and a detector 16 for detecting a change in energy distribution within the energy-transmitting layer 14. The energy source 12 may be, for example, a light source, a current source, or any other source of energy. The energy transmitted through the transmitting layer 14 creates an energy distribution profile within the energy-transmitting layer 14 that generally doesn't fluctuate over time. In certain embodiments, the energy distribution profile may be uniform.

The energy-transmitting layer 14 may be selected based on the type of energy source 12 employed. For example, if a light source is employed, the energy-transmitting layer 14 may be made of at least a partially optical transmissive material, such as Polycarbonate (PC), Polyethylene (PE), Polypropylene (PP), Polystyrene (PS) foil, or glass. Similarly, if a current source is employed, the energy-transmitting layer 14 may be made of a generally electrically conductive material. In one embodiment, the material used for energy-transmitting layer has high reliability and/or high mechanical durability. In certain embodiments, the energy-transmitting layer 14 may be optimized so as to minimize the energy loss and thus to minimize the power consumption. For example, in embodiments where a light source is employed, the optical transmitting layer may be doped with fluorescent material, such as dyes and/or quantum dots to minimize the optical attenuation. Additionally, the energy-transmitting layer 14 may be coated on one or more surfaces with an energy reflecting material to minimize energy losses and capture the maximum portion of energy within the energy-transmitting layer 14. For example, based on the type of source employed, a light reflecting material or an insulation material may be used for the coating. As will be appreciated by one skilled in the art, the energy-transmitting layer 14 may be fabricated as a foam, a film, a foil, a plate, or other substrate configuration and may be disposed on or within a surface of a container, a package, a door, or a window that is vulnerable to breach. It should be noted that, the position (external, or internal) of the energy-transmitting layer 14 with respect to the surface vulnerable to breach (breachable surface) may be based on the application requirements. As used herein, the term “breachable surface” means a surface vulnerable to breach, tamper and/or intrusion. Further, optical or electrical layer design may be based on the application. Any event of tampering and/or intrusion of the surface vulnerable to breach will result in change in energy distribution profile within the energy-transmitting layer and will be therefore detected.

The detector 16 may be, for example, a current-sensing device for sensing a change in current density, a light-sensing device for sensing a change in light intensity (flux), or any other device configured to detect a change in the energy distribution within the energy-transmitting layer 14. Alternatively, the detector may be configured to detect and measure the level of energy distribution within the energy-transmitting layer 14 at any given instant. The measured energy distribution may then be compared against the normal level of energy distribution (threshold value) or a previous measurement via acquisition circuitry provided internal or external to the detector 16 and a change may thereby be detected. The tamper and/or intrusion detection system 10 may further include an alarm system 17 coupled to the detector 16. The alarm system 17 may trigger an alarm whenever the detector detects a change in energy distribution within the energy-transmitting layer 14.

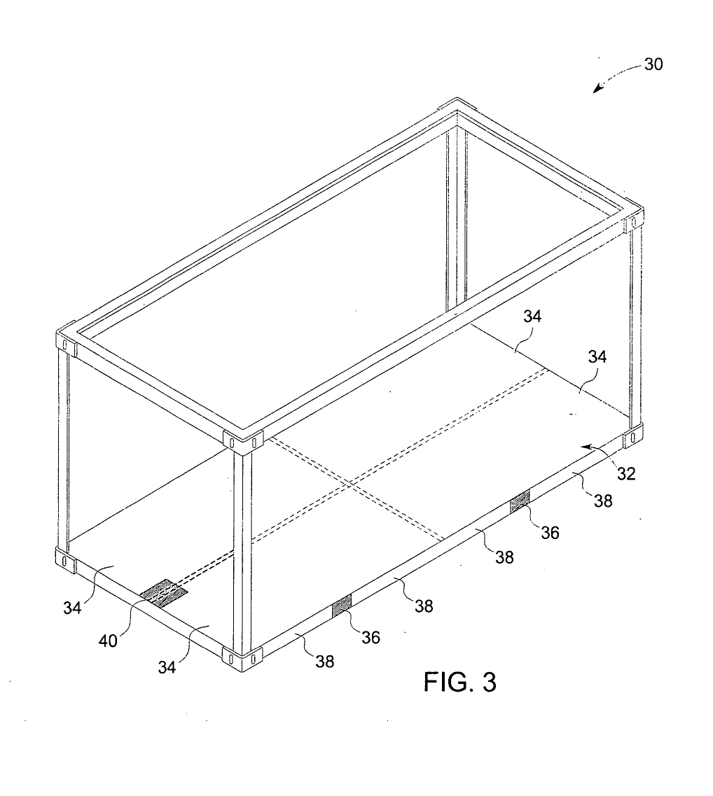

FIG. 2 illustrates an exemplary tamper and/or intrusion detection system of FIG. 1 employing a light source in accordance with aspects of the present technique. As illustrated, the tamper and/or intrusion detection system 18 includes a light source (transmitter) 20 such as light emitting diode (LED) or a fiber illuminator for illuminating an optical transmitting layer 22. The optical transmitting layer 22 may be made of at least a partially optical transmissive material, such as LEXAN®, that offers low attenuation to the light. The optical transmitting layer 22 is lighted with monochromatic, infrared (IR), or white light 24 from the light source 20. The transmitted light 24 travels through the optical transmitting layer 22 and establishes a distribution profile of light flux within the optical transmitting layer 22. The one or more exposed surfaces of the optical transmitting layer 22 may be coated with reflecting material 26 to increase the light flux within the optical transmitting layer 22 via total internal reflection. The tamper and/or intrusion detection system 18 further includes a light sensor (receiver) 28 for sensing any change in light flux within the optical transmitting layer 22. Alternatively, the light sensor 28 may be configured to detect and measure the amount of light flux within the optical transmitting layer 22 at any given instant. The measured flux is then compared against the expected level of light flux (threshold value) and a deviation from the threshold value may be detected. Any event that results in a change in light flux within the optical transmitting layer 22 will be detected and may cause alarm. As will be appreciated by one skilled in the art, the light source 20 and the light sensor 28 may be placed in any suitable configuration relative to the optical transmitting layer 22.

As will be appreciated by one skilled in the art, the tamper and/or intrusion detection system 10 such as those described above may be provided in wide variety of structures such as cargo containers, packages, doors, windows or any other structures that are vulnerable to breach to make them secure and tamperproof. For example, an exemplary tamperproof structure 30, such as a cargo container, is illustrated in FIG. 3 in accordance with aspects of the present technique. The tamper and/or intrusion detection system may be installed on one or more breachable surface 32 of the tamperproof structure 30. Further, each of the breachable surfaces 32 may be divided into one or more portions 34 and each divided portion may be made tamperproof. Thus, each portion 34 may independently include one or more energy sources 36, one or more detectors 38 and an energy-transmitting layer disposed on or within the respective area of the breachable surface as described in greater detail below. The structure 30 may also include a central controller 40 for monitoring the detected signals and detecting any change in the energy distribution within the energy-transmitting layer. The central controller 40 may be coupled to an alarm system to trigger alarm on detecting intrusion or tampering. Further, as will be appreciated by one skilled in the art, the central controller 40 may be coupled to a remote monitoring or alarm system via a network interface, such as wireless LAN port, Bluetooth port, Serial RS 232 port, or a fiber optic link.

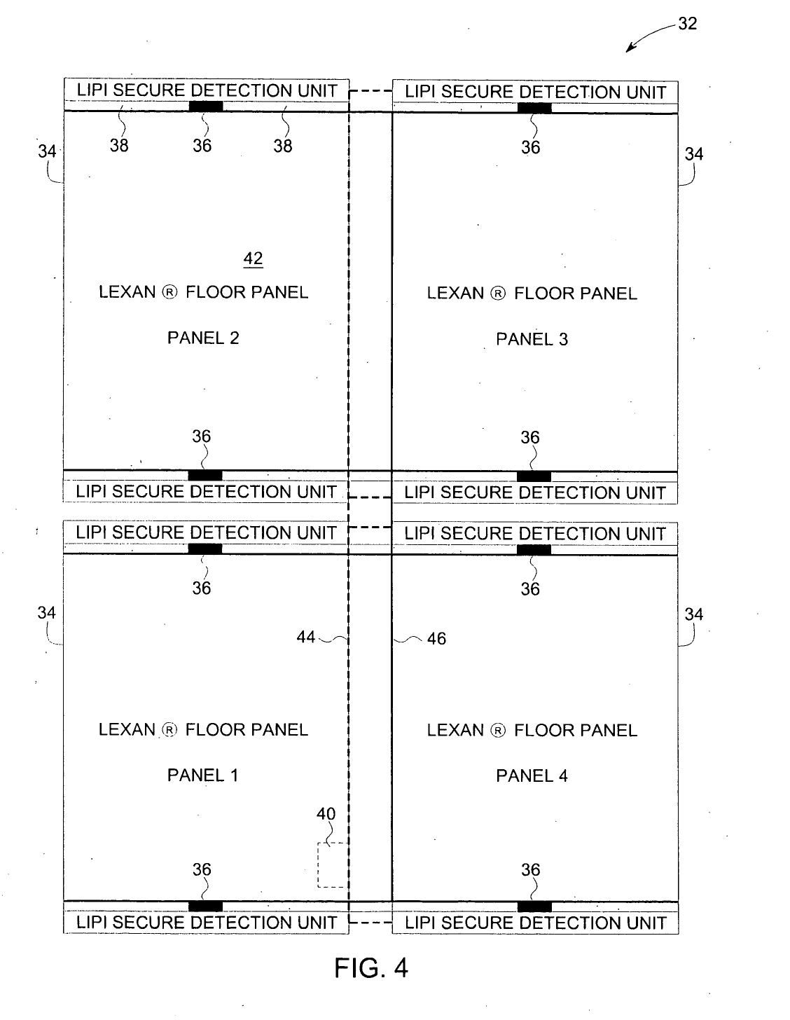

An overall plan for one of the breachable surfaces 32 of a tamperproof structure 30 is illustrated in FIG. 4 in accordance with one aspect of the present technique. As illustrated, the breachable surface 32 is divided into four portions 34. Each of the four portions 34 independently includes an optical transmitting layer 42, such as a LEXAN® layer, disposed on or within the breachable surface, illumination sources 36 for illuminating the optical transmitting layer 42, and detection units 38, such as LIPI secure detection units, for detecting change in the light intensity within the optical transmitting layer 42. Each of the illumination sources 36 is fed via one or more fiber optic cables 44 and each of the detection units 38 is coupled to the central controller 40 via one or more electrical wires 46. It should be noted that the wiring may be integrated into the surface of the structure 30.

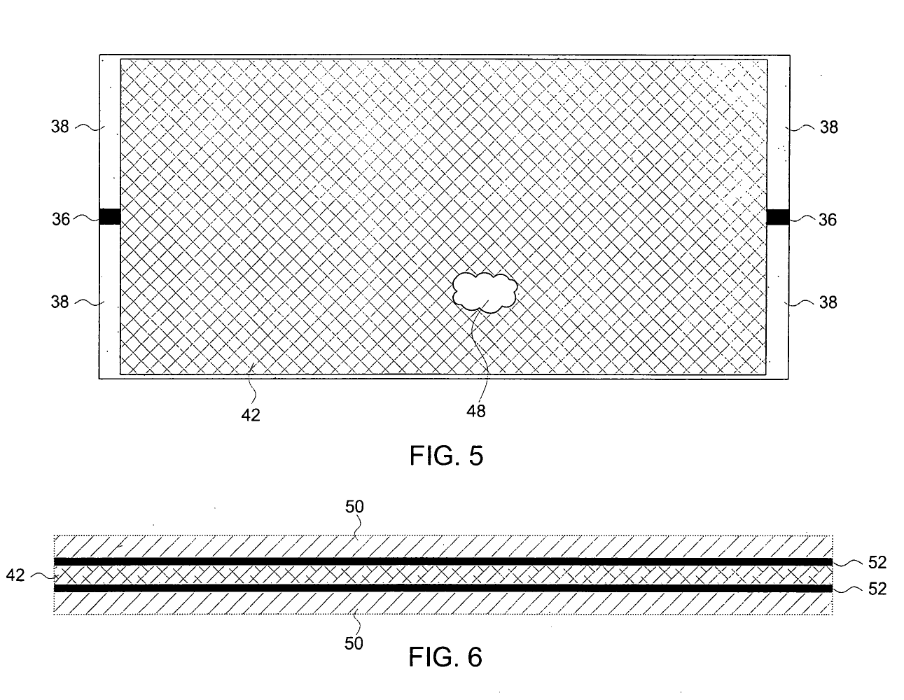

A planar view of one of the portions 34 of a breachable surface 32 of the tamperproof structure 30 is illustrated in FIG. 5. In the illustrated embodiment, two energy sources 36 are placed on opposite edges of an energy-transmitting layer 42. Further a set of four detectors 38 is employed in the illustrated configuration to detect any change in the energy distribution profile within the energy-transmitting layer 42 due to a breach 48. As described above, the energy-transmitting layer 42 may be disposed on or within the breachable surface 32 of FIGS. 3 and 4. A cross sectional view of one of the breachable surfaces 32 of the tamperproof structure 30 is illustrated in FIG. 6. A layer of energy-transmitting material 42, such as glass fiber composite (GFC) or LEXAN®, may be disposed between two layers of surface material 50, such as plywood or AZDEL or other composite materials. Additionally, the surface of the energy-transmitting layer 42 may be coated with an energy reflecting material 52 to minimize the energy loss. Further, the energy-transmitting layer 42 may be doped with fluorescent material, such as dyes and/or quantum dots, to minimize the optical attenuation.

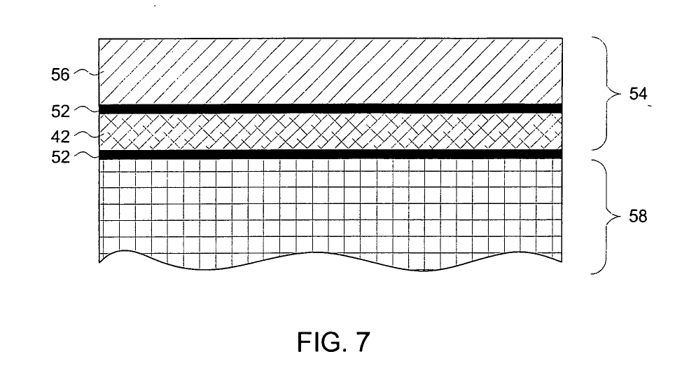

As will be appreciated by one skilled in the art, the tamper and/or intrusion detection system may also be retrofitted into an existing structure (cargo containers, packages, doors, windows and so forth) to make them tamperproof. A cross sectional view of retrofit solution 54 to make an existing structure tamperproof is illustrated in FIG. 7 in accordance with aspects of the present technique. The retrofit solution 54 includes the energy-transmitting layer 42 and a layer of encapsulating material 56, such as plywood, AZDEL, or any other composite material, to provide protection to the energy-transmitting layer 42. Additionally, a layer of energy reflecting material 52 may be coated on the surface of the energy-transmitting layer 42 to minimize the energy loss. The energy-transmitting layer 42 may also be doped with fluorescent material to minimize the optical attenuation. The retrofit solution 54 further includes an energy source disposed on one end of the energy-transmitting layer for creating an energy distribution profile within the energy-transmitting layer and a detector disposed on another end of the energy-transmitting layer for detecting a change in the energy distribution profile. The retrofit solution 54 may also include an alarm system coupled to the detector that triggers when the detector detects the change in the energy distribution profile. The retrofit solution 54 may be fitted on a breachable surface 58 of the existing structure by gluing, welding, or other techniques for mechanically and/or chemically attaching structures. The breachable surface 58 may be made of plywood, AZDEL® or any other composite material.

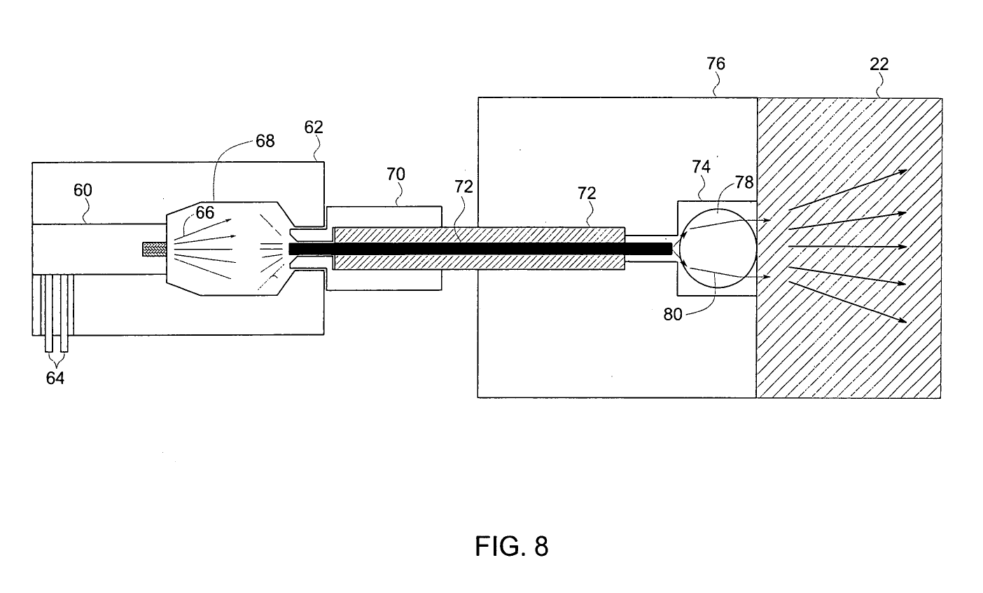

A schematic arrangement to provide light/illumination to the tamper and/or intrusion detection system described in the various embodiments discussed above is illustrated in FIG. 8 in accordance with aspects of the present technique. In the illustrated embodiment, one or more light sources 60, such as light emitting diodes (LEDs), are disposed in a case 62. The light sources 60 may be provided with electrical connections 64 and are configured to emit light 66 in an opening 68 within the case 62 upon activation. A fiber optic plug 70 is coupled to the case 62 such that a fiber optic cable 72 disposed within the fiber optic plug 70 collects the emitted light 66 from the opening 68. The inner surface of the opening 68 may be coated with reflecting material to reflect almost all of the emitted light 66 towards the fiber optic cable 72. The other end of the fiber optic cable 72 is coupled to an optical gel 74. The optical gel 74 and a part of the fiber optic cable 72 is encapsulated in an encapsulating material 76, such as BAYFLEX® or RETICEL®, which provides protection against moisture and/or mechanical shock. The emitted light 66 is delivered into the optical gel 74 via the fiber optic cable 72. Further, a ball lens 78 suspended within the optical gel 74 expands and directs the incoming light 80 into the optical transmitting layer 22.

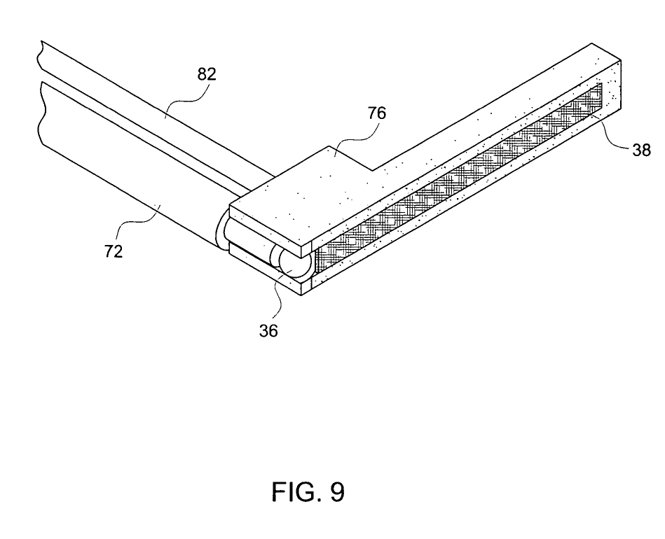

An emitter-sensor package for installation in the tamperproof structure 30 is illustrated in FIG. 9 in accordance with one aspect of the present technique. The emitter 36 and the sensor 38 are disposed within an encapsulating material 76, such as BAYFLEX®, to prevent any damage from shock or moisture. The light emitter is provided via the optical fiber 72 as described above. Alternatively, a current emitter may be provided via an electrical cable 82. The sensor 38 is coupled to the central controller via the electrical cable 82. The complete package may be coupled to the optical transmitting layer, such as LEXAN®.

The tamper and/or intrusion detection system described in various embodiments discussed above enables detection of tampering and/or intrusion by monitoring the light intensity in the optical layer or current density in the electrical layer of the breachable surface. The optical and/or electrical coating (such as sensitized plastic) may be applied to encapsulate the good. If a damage to the sensitized plastic package is inflicted a detector will register the event and initiate an alarm. The floor of a cargo container may be a glass fiber composite (GFC) material coated on plywood. The GFC could be used as fiber-wire detection system. Alternatively, an additional plastic layer (such as LEXAN®) may be added and used as sensing device. In certain embodiments, the system includes a low power optimized light or electric transmitter (such as LED or current source), low light or current dissipating optical or electrical film, and a light or electric sensing device.

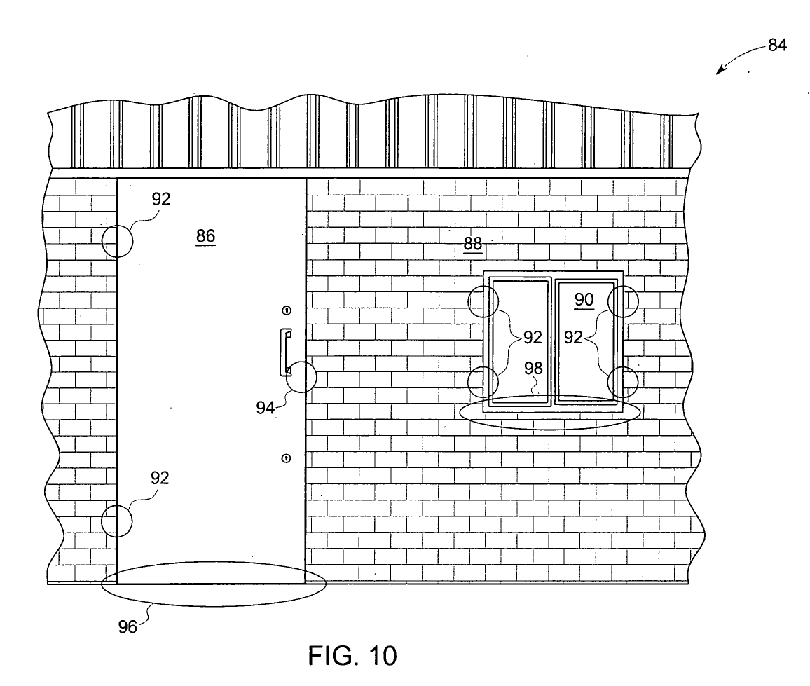

As will be appreciated by the one skilled in the art, the tamper and/or intrusion detection system described above may be employed in areas other than security of cargo containers and/or packages. For example, with some modification the system described above may be employed to prevent intrusion in public and/or private premises 84 as illustrated in FIG. 10 in accordance with aspects of the present technique. The tamper and/or intrusion detection system described above may be installed in doors 86, walls 88, or windows 90 of any premises 84. In the illustrated embodiment, the energy source may be fitted into hinges 92 of doors and windows as well as into locking systems 94 of the door as will be described in greater detail below. The energy-transmitting layer is disposed on or within the surface of the door panels and the windows panels. The detectors or the sensors are placed at defined edges 96, 98 of the doors and the windows respectively. An intrusion by cutting through the doors or windows will influence the energy distribution within the energy-transmitting layer. This change will be reflected by the detector signals, thereby causing alarm.

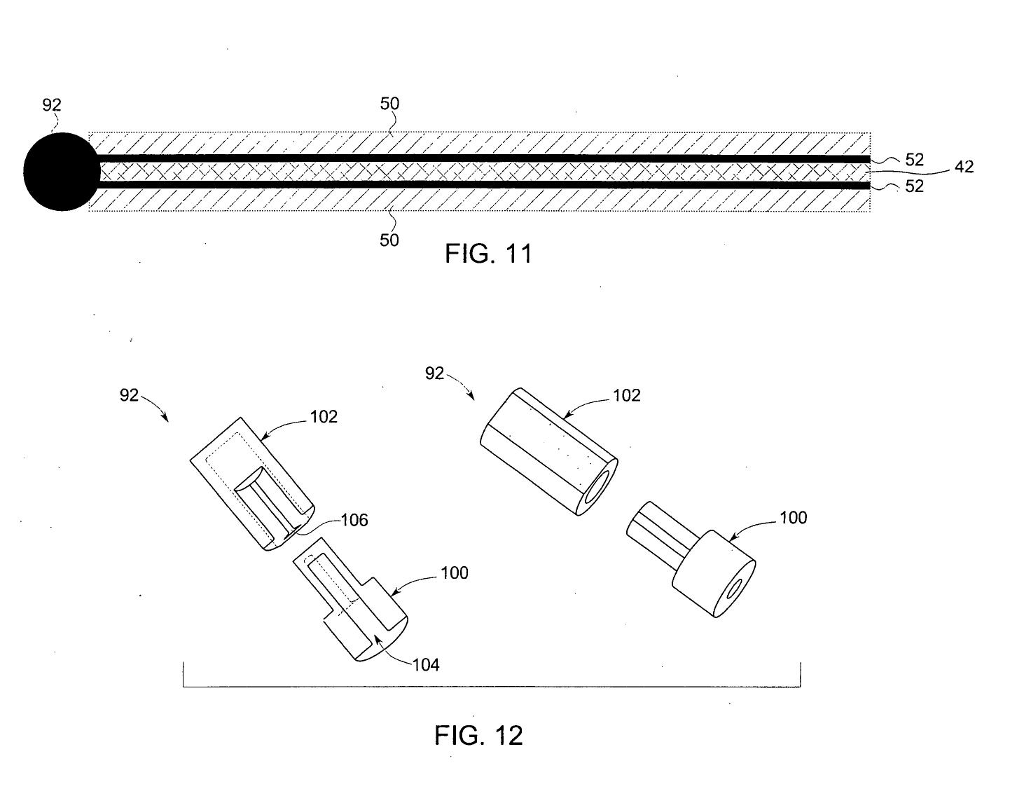

A cross sectional view of door or window panels is illustrated in FIG. 11 in accordance with aspects of the present technique. The panels include energy-transmitting layer 42 disposed within the surface 50 of the doors or windows. Optionally, the energy-transmitting layer 42 is coated with energy reflecting material 52 to prevent energy losses. Further, the hinges 92 or locks may include energy sources. The detectors may be installed on the sides and coupled to the central controller and further to alarm system. As will be appreciated by one skilled in the art, the tamper and/or intrusion detection system described above may be installed within the doors or windows or may be retrofitted into existing doors or windows. Further, as will be appreciated by one skilled in the art, the tamper and/or intrusion detection system may also be installed within or retrofitted on the walls of the secured premises.

In one embodiment, an optical transparent material may be disposed in the door. The material is illuminated with a monochromatic, infrared (IR), or white light from defined light sources disposed in locks and/or hinges. The hinge and locks are so designed, that they provide light only in the closed status of the door (alarm status). As the light is directed at these injection points (hinges and/or locks), fluorescent dyes or quantum dots may be used to ensure a homogeneous distribution of the light. An intrusion through the door will influence the light flow in the optical material, resulting in a change in detector signal and thus causing an alarm. Further, if the hinges or locks are removed to open the door the light transmission into the system is disconnected, thereby influencing the light flow in the optical material and causing alarm. For energy saving purposes a pulsed light insertion may be employed.

The tamperproof hinge 92 is illustrated in FIG. 12 in accordance with aspects of the present technique. A part of the hinge 100 is connected to the walls while the other part 102 is fitted into door panels or windows panels. An energy source 104 may be disposed within the part 100 fitted to the wall. The hinge may be modified to allow the transmission of energy to the panels when parts 100 and 102 are in contact with each other via an energy conductive channel 106, such as fiber optic cable or an electrical cable. The energy is then transmitted through the energy-transmitting medium disposed on or within the panels. It should be noted that, the hinges are configured to provide energy only when the door is closed. Thus, when the hinges are removed when the door is closed, the source is cut off leading to a change in energy distribution within the energy-transmitting layer and thereby causing alarm.

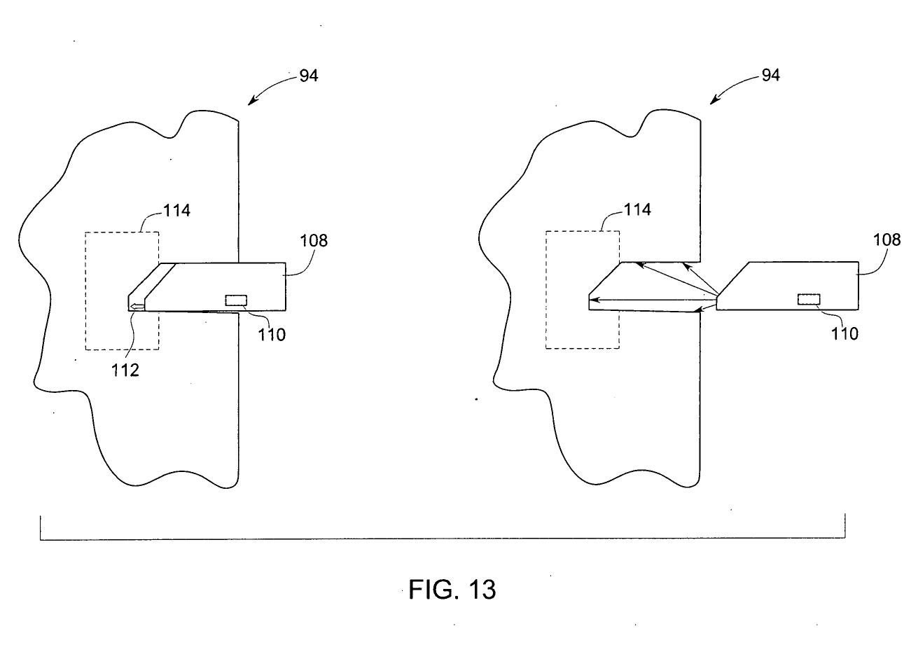

The tamperproof locking system 94 is illustrated in FIG. 13 in accordance with aspects of the present technique. The lock 108 may be provided with an energy source 110 and may be configured to provide energy only when the door is closed. Thus, in the closed position, the lock transmits energy through the energy-transmitting layer disposed on or within the panels via an energy conductive channel 112. Any attempt to intrude by removing the lock will cut off the energy source resulting in a change in the energy distribution within the energy-transmitting layer and thereby causing alarm. Moreover, an intrusion by cutting through the panel when the door is closed will lead to a change in energy distribution within the energy-transmitting layer, thereby causing alarm. Further, in embodiments where a light source is used, fluorescent dyes or quantum dots 114 may be used to ensure a homogeneous distribution of the light. As will be appreciated by one skilled in the art, optical or electrical sources may be employed for tamper/intrusion detection and the optical or electrical layer design may be selected based on the application.

The tamper and/or intrusion detection techniques for securing premises described in the embodiments discussed above enable the detection of an intrusion through doors, windows and/or walls. The techniques cover not only an effect but also the intrusion itself and sound an alarm before the burglar could enter the secured area. As the technique detects directly the effect of intrusion based on the change in energy distribution resulting of the intruded area or the disconnection of the energy sources at opening or quarry out of the doors or windows, the alarm system reacts only on the effect of intrusion or opening of doors, thereby reducing the false alarms. Furthermore, apart from the whole door and/or window area, the connections to the walls are also monitored. Additionally, the system is hidden not only to the intruders, but also to the customers and thus provides no negative impact on the appearance of the door. The principle works also for fully transparent doors.

Moreover, the tamper and/or intrusion detection system described in the various embodiments discussed above is reliable (low failure detection tolerance), durable (greater than 5 years), inexpensive, efficient (reduced false alarm and low energy consumption), and can be mass manufactured. Further, the system is self-checking, thereby cutting down redundant quality and/or security checking costs.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A tamper detection system, comprising:
an energy source for transmitting energy through an energy-transmitting layer; and
a detector for detecting a change in energy distribution within the energy-transmitting layer.

2. The tamper detection system of claim 1, wherein the energy source comprises a current source or a light source.

3. The tamper detection system of claim 1, wherein the energy-transmitting layer comprises a layer which is at least partially optically transmissive or an electrical conductive layer.

4. The tamper detection system of claim 1, wherein the energy-transmitting layer comprises a foam, a film, a foil, or a plate.

5. The tamper detection system of claim 1, wherein the energy-transmitting layer is disposed on or within a breachable surface of a container, a package, a door, or a window.

6. The tamper detection system of claim 1, wherein the energy-transmitting layer is doped with fluorescent material to minimize optical attenuation.

7. The tamper detection system of claim 1, wherein the detector comprises a current sensing device for sensing a change in current density or a light sensing device for sensing a change in light intensity.

8. The tamper detection system of claim 1, further comprising an alarm system coupled to the detector, wherein the alarm triggers when the detector detects the change in energy distribution within the energy-transmitting layer.

9. A tamperproof structure, comprising:
at least one surface vulnerable to breach, the surface comprising an energy-transmitting layer;
an energy source for transmitting energy through the energy-transmitting layer; and
a detector for detecting a change in energy distribution within the energy-transmitting layer.

10. The tamperproof structure of claim 9, wherein the surface vulnerable to breach is a door, a window, a surface of a cargo container, or a surface of a package box.

11. The tamperproof structure of claim 9, wherein the energy-transmitting layer is disposed on or within the surface vulnerable to breach.

12. The tamperproof structure of claim 9, wherein the energy-transmitting layer is coated with a material to minimize energy loss.

13. The tamperproof structure of claim 9, wherein the energy-transmitting layer comprises a layer which is at least partially optically transmissive.

14. The tamperproof structure of claim 13, wherein the layer is doped with a fluorescent material to minimize the optical attenuation.

15. The tamperproof structure of claim 13, wherein the layer is coated with a reflecting material to minimize optical loss via total internal reflection.

16. The tamperproof structure of claim 13, wherein the energy source comprises a light source configured to illuminate the layer.

17. A kit for upgrading a structure, the kit comprising:
an energy-transmitting layer;
an energy source configured to be disposed on one end of the energy-transmitting layer, wherein the energy source is adapted to create an energy distribution profile within the energy-transmitting layer; and
a detector configured to be disposed on another end of the energy-transmitting layer, wherein the detector is configured to detect a change in the energy distribution profile.

18. The kit of claim 17, further comprising an alarm system configured to be coupled to the detector, wherein the alarm triggers when the detector detects the change in the energy distribution profile.

19. The kit of claim 17, wherein the energy source comprises a current source or a light source.

20. The kit of claim 17, wherein the energy-transmitting layer comprises a layer which is at least partially optically transmissive or electrically conductive.

21. The kit of claim 17, wherein the detector comprises a current sensing device for sensing a change in current density or a light sensing device for sensing a change in light intensity.

22. A method of detecting tampering of a surface vulnerable to breach, the method comprising:
creating an energy distribution profile within an energy-transmitting layer, wherein the energy-transmitting layer is disposed on or within the surface vulnerable to breach; and
detecting a change in the energy distribution profile.

23. The method of claim 22, further comprising generating an alarm in response to the change in the energy distribution profile.

24. A method of making a structure tamperproof, the method comprising:
disposing an energy-transmitting layer on or within a surface of the structure, the surface being vulnerable to breach;
disposing an energy source on one end of the energy-transmitting layer; and
disposing a detector on another end of the energy-transmitting layer.

25. The method of claim 24, wherein the surface vulnerable to breach is a door, a window, a surface of a cargo container, or a surface of a package.

26. The method of claim 24, wherein the energy-transmitting layer comprises a layer which is at least partially optically transmissive or electrically conductive.

27. The method of claim 26, further comprising doping the optically transmissive layer with a fluorescent material to minimize the optical attenuation.

28. The method of claim 26, further comprising coating the optically transmissive layer with a reflecting material to minimize optical loss.
